(19) United States
(12) Patent Application Publication
(10) Pub. No.: US 2002/0058234 A1
(43) Pub. Date: May 16, 2002

(54) System and method for teaching a language with interactive digital televison

(76) Inventors: Stephen G. West, Chapel Hill, NC (US); Paul Meade, Chapel Hill, NC (US)

Correspondence Address: MATHEWS, COLLINS, SHEPHERD & GOULD, P.A., 100 THANET CIRCLE, SUITE 306, PRINCETON, NJ, 08540-3674, US

(21) Appl. No.: 10/043,475

(22) Filed: Jan. 11, 2002

Related U.S. Application Data
(60) Provisional application No. 60/260,983, filed on Jan. 11, 2001.

(51) Int. Cl. G09B 19/06

(52) U.S. Cl. 434/157

(57) ABSTRACT

The present invention is a system and method for teaching a language with interactive digital television. In one embodiment of the present invention, audio and visual material in digital format is presented on an interactive digital television, exposing the user to the audio visual material in digital format, wherein the audio visual material in digital format contains a predetermined amount of foreign language content. The predetermined amount of foreign language content is progressively increased.

### CROSS REFERENCES TO RELATED APPLICATIONS

This application claims the benefit under 35 U.S.C. 119(e) of U.S. Provisional Application Serial No. 60/260,983 filed on Jan. 11, 2001.

### FIELD OF THE INVENTION

This invention relates to the field of digital communications, and more particularly to teaching a subject with interactive digital communications.

### BACKGROUND OF THE INVENTION

Interactive digital systems enable interactive digital services in the home. The digital subsystem is similar to that employed in broadcast digital devices with the addition of an allocated forward path to the user and a return path to the local network gateway. The return path allows these set-top boxes to request digital services, such as video-on-demand, from servers deployed by content providers across the network. The return path also provides a two-way data stream to enable interactivity for such applications as electronic shopping and networked games.

The once separate domains of computers, communications, and entertainment are currently melding to form a new marketplace, one that directly affects the world of individual consumers. The promise of this convergence is a new era of service and convenience that enables consumers to retrieve information, shop from home, participate in governmental forums, play the latest games with partners around the country, and order video-on-demand through simple interactions with their television set.

Interactive digital systems can also be used for remote and distance learning, providing new educational opportunities.

### SUMMARY OF THE INVENTION

The present invention is a system and method for teaching a user a foreign language. The user is provided with digital audio and visual material. The user is exposed to the digital audio visual material containing a predetermined amount of foreign language content. As the user progresses with the digital audio visual material, the predetermined amount of foreign language content is progressively increased.

### BRIEF DESCRIPTION OF THE DRAWINGS

A more complete understanding of the present invention may be obtained from consideration of the following description in conjunction with the drawings in which:

FIG. 1 is a stylized overview of interconnected computer system networks; and,

FIG. 2 is a simplified functional view of a set-top box capable of supporting broadcast analog, broadcast digital, and interactive digital transmission.

### DETAILED DESCRIPTION OF VARIOUS ILLUSTRATIVE EMBODIMENTS

Although the present invention is particularly well suited for use digital interactive television and shall be so described, the present invention is equally well suited for use in other network communication systems such as the Internet, an Intranet, Interactive television (iTV) and similar interactive communication systems.

The Internet is a worldwide system of computer networks—a network of networks in which users at one computer can obtain information from any other computer (and communicate with users of the other computers).

The Internet has evolved into a public, cooperative, and self-sustaining facility accessible to hundreds of millions of people worldwide. Physically, the Internet uses a portion of the total resources of the currently existing public telecommunication networks. Technically, what distinguishes the Internet is its use of a set of protocols called Transmission Control Protocol/Internet Protocol (TCP/IP).

For many Internet users, electronic mail (e-mail) has essentially all but replaced the Postal Service for short written transactions. E-mail is the most widely used application on the Internet. Live “conversations” can be carried on with other computer users, using Internet Relay Chat (IRC). More recently, Internet telephony hardware and software allows real-time voice conversations.

The most widely used part of the Internet is the World Wide Web (often abbreviated “WWW” or called “the Web”). The most outstanding feature of the Web is its use of hypertext, which is a method of instant cross-referencing. In most Web sites, certain words or phrases appear in text of a different color than the rest; often this text is also underlined. When one of these words or phrases is selected, it's a hyperlink, transferring the user to the site or page that is relevant to this word or phrase. Sometimes there are buttons, images, or portions of images that are “clickable.” Using the Web provides access to millions of pages of information. Web “surfing” is done with a Web browser; the most popular of which presently are Netscape Navigator and Microsoft Internet Explorer. The appearance of a particular Web site may vary slightly depending on the particular browser used. Recent versions of browsers have plug-ins, which provide animation, virtual reality, sound, and music.

Because the Internet evolved from the ARPAnet, a research experiment that supported the exchange of data between government contractors and (often academic) researchers, an on-line culture developed that is alien to the corporate business world. Setting up e-commerce provides low overhead while reaching a worldwide market 24 hours a day. The growth and popularity of the Internet is providing new opportunities for commercialization including but not limited to Web sites driven by electronic commerce, ad revenue, branding, database transactions, and intranet/extranet applications.

Domain names direct where e-mail is sent, files are found, and computer resources are located. They are used when accessing information on the Web or connecting to other computers through Telnet. Internet users enter the domain name, which is automatically converted to the Internet Protocol address by the Domain Name System (DNS).

E-mail was one of the first services developed on the Internet. Today, e-mail is an important service on any computer network, not just the Internet. E-mail involves sending a message from one computer account to another computer account. E-mail is used to send textual information as well as files, including graphic files, executable files, word processing and other files. E-mail is becoming a popular way to conduct business over long distances. Using e-mail to contact a business associate can be faster than using a voice telephone, because the recipient can read it at a convenient time, and the sender can include as much information as needed to explain the situation.

On-line commerce, or “e-commerce”, uses the Internet, of which the Web is a part, to transfer large amounts of information about numerous goods and services in exchange for payment or customer data needed to facilitate payment. Potential customers can supply a company with shipping and invoicing information without having to tie up sales staff. The convenience offered to the customer is that they don't have to drive around town all day looking for the product they want.

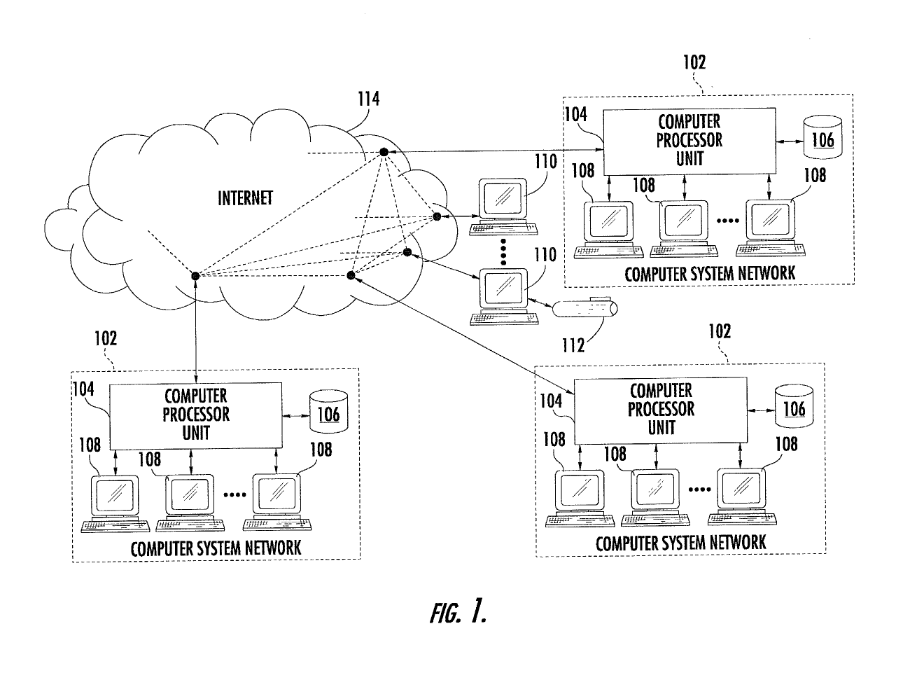

Referring to FIG. 1 there is shown a stylized overview of interconnected computer system networks. Each computer system network 102 contains a corresponding local computer processor unit 104, which are coupled to a corresponding local data storage unit 106, and local network users 108. The local computer processor units 104 are selectively coupled to a plurality of users 110 through the Internet 114. Each of the plurality of users 110 may have various devices connected to their local computer systems such as scanners, bar code readers, RFID detectors and other interface devices 112. A user 110 locates and selects (such as by clicking with a mouse) a particular Web page, the content of which is located on the local data storage unit 106 of the computer system network 102, to access the content of the web (world wide web) page. The web page may contain links to other computer systems and other web pages.

Interactive digital systems enable interactive digital services in the home. The digital subsystem is similar to that employed in broadcast digital devices with the addition of an allocated forward path to the user and a return path to the local network gateway. The return path allows these set-top boxes to request digital services, such as video-on-demand, from servers deployed by content providers across the network. The return path also provides a two-way data stream to enable interactivity for such applications as electronic shopping and networked games.

The once separate domains of computers, communications, and entertainment are currently melding to form a new marketplace, one that directly affects the world of individual consumers. The promise of this convergence is a new era of service and convenience that enables consumers to retrieve information, shop from home, participate in governmental forums, play the latest games with partners around the country, and order video-on-demand through simple interactions with their television set.

The formation of this new interactive market stems from a number of contributing factors, including:

Digital video and audio compression standards enable silicon implementations to deliver high quality content cost effectively.

New generations of fiber-based networks, being deployed around the world, have the range and capacity to deliver vastly increased data bandwidths, hundreds of millions to several billions of bits per second, to consumer homes.

Government deregulation has fostered a new competitive playing field between telecommunications and cable communications providers.

Increased computing power and faster networks have enabled new applications that incorporate complex multimedia elements and interactive communications. Development tools for building these applications are moving from a PC and CD-ROM focus toward networked interaction support.

Home communications terminals are evolving to capitalize on these trends. These devices combine high-speed media processing hardware with broadband network interfaces to transform today's consumer television sets into interactive multimedia entertainment systems.

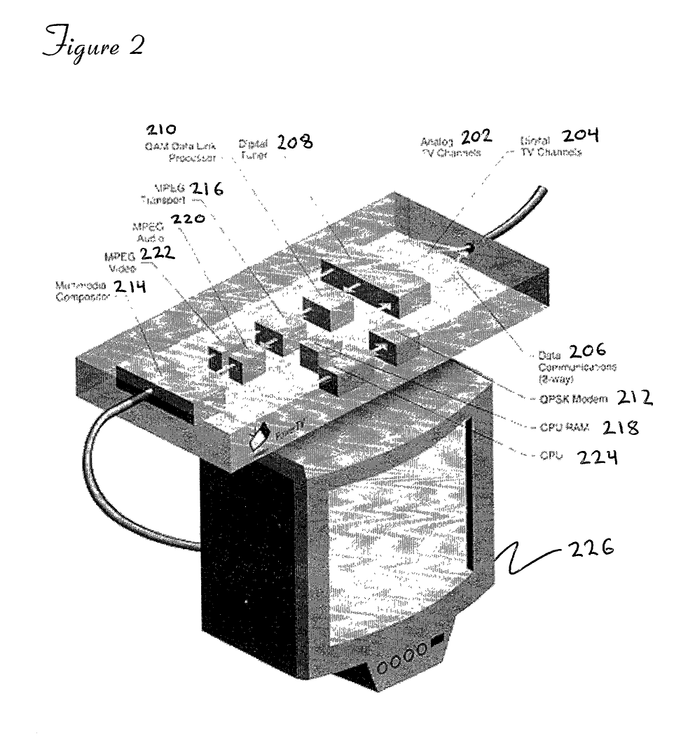

Referring to FIG. 2, there is shown a simplified functional view of an exemplary embodiment of a set-top box capable of supporting broadcast analog, broadcast digital, and interactive digital transmission. There are three sources of network input to this device:

Analog video channels

Digital video channels, which support broadband communications over HFC connections using Quadrature Amplitude Modulation (QAM)

Control channels for two-way signaling and messaging using

Quaternary Phase Shift Keying (QPSK)

The analog input 202, digital input 204 and two way data communications 206 are coupled to a digital tuner 208. a QAM Data Link Processor 210, QPSK modem 212 and a media compositor 214 are coupled to the digital tuner 208. An MPEG transport module 216 is coupled to the QAM data link processor 210, CPU RAM 218, MPEG audio module 220, and MPEG video module 222. A CPU 224 is coupled to the multimedia compositor 214, the CPU RAM 218 and the QPSK modem 212. The multimedia compositor 214 is coupled to a digital set 226.

For analog broadcast systems, analog modulation and optional encryption schemes deliver the video and audio content to the digital set-top box, where it is demodulated, decrypted where necessary, and optionally digitized. The resulting analog signal or digital stream is routed to the multimedia compositor, an application-specific integrated circuit (ASIC) that mixes the program content using analog or digital techniques as appropriate.

Digital QAM channels carry compressed and encoded multi-program MPEG transport streams. Once inside the set-top box, the QAM signal is demodulated and error corrected before entering the MPEG transport system. The transport system extracts the desired program from the transport stream. It then separates the audio, video, and data components, which are routed to the audio decoder, video decoder, and CPU RAM respectively.

The multimedia compositor 214 generates a display image from video and audio input streams and CPU-generated media. It combines graphics and text, generated by applications running in the digital set-top box, with full-motion MPEG-2 or analog video. The composition of graphics and video includes translucent alpha-blending of the two, scaling of motion video into a window, and the overlay of graphics and video. Similarly, the multimedia compositor 214 combines application audio with MPEG and analog broadcast audio, mixing simultaneous networked and local sounds—either sampled or synthesized—into a single signal.

In an interactive digital environment, QPSK channels 206 provide transparent two-way communications between the user and the content provider. Database queries to content providers travel over these channels to provide users with a choice of interactive entertainment options. While applications are running, these channels transmit user commands such as play video, pause, or fast-forward to the content source. They also allow for the request and delivery of graphics, fonts, and other data.

The deployment of digital services and set-top boxes is already under way in various locations around the globe. During the transition, networks will interoperate with both digital and analog set-top boxes. Most digital set-top boxes also provide compatible analog functionality.

The present invention is suited for implementation utilizing a number of developmental tools that are known to those skilled in the art. An overview the software architecture to support the applications and services of interactive television can be found in a white paper entitled Applications and Service Infrastructure by PowerTV, Inc., Dec. 5, 1997, which is incorporated herein by reference as if fully set out in this document.

The present invention is a system and method for teaching a language with interactive digital television. In one embodiment of the present invention, the PI Language Method is implemented in a digital format. This implementation can then be 1) broadcast over digital interactive television, 2) downloaded over an electronic network, such as the Internet, through video streaming technology, and 3) downloading different digital audio formats over an existing digital video format.

The PI Language Method involves providing a media series for teaching a given language to one or more users. The media series utilizes the given language and a language other than the given language. The media series has a plurality of series lessons, which sequentially contain an increasing percentage of the given language. Each of the plurality of series of lesions utilizes the given language in context such that its meaning can be obviously and intuitively understood by said one or more users. Each user is progressively exposed to the series of lessons in sequential fashion.

One embodiment of the present invention involves implementing the PI Language Method in a digital format suitable for interactive digital television. This method comprising the steps of:

A) Using existing or new audiovisual material that has been modified to represent the PI Language Method for purposes of teaching languages and converting this modified material into a digital format suitable for interactive digital television.

B) Exposing users to such digitalized material through interactive digital television that can be delivered to said users via broadcast, cable, or satellite technologies.

Yet another embodiment of the present invention involves implementing the PI Language Method in a digital format suitable for downloading to digital storage media, such as CD-ROM, DVD, etc., over an electronic network, such as the Internet, with the method comprising the steps of:

A) Using existing or new audiovisual material that has been modified to represent the PI Language Method for purposes of teaching languages and converting this modified material into a digital format suitable for downloading to digital storage media via an electronic network, such as the Internet

B) Exposing users to such digitalized material through real-time video streaming technologies or downloading technologies via dial-up telephone technologies, cable technologies, or satellite technologies for purposes of learning languages.

Yet a further embodiment of the present invention involves implementing the PI Language Method in a digital format such that various audio series of the PI Language Method can be downloaded to a digital storage medium already containing the PI Language Method and one or more existing audio series of the PI Language Method, with the method comprising the steps of:

A) Using existing or new audiovisual material that has been modified to represent the PI Language Method for purposes of teaching languages and converting this modified material into a digital format suitable for downloading different audio series that can replace the existing audio portion of the PI Language Method series without altering the video portion of the existing PI Language Method portion, whereas said different audio series could be in the same language as the existing audio portion on the digital storage medium, or different languages than the existing audio portion of the PI Language Method.

B) Exposing users to such digitalized audio portions through downloading technologies via dial-up telephone technologies, cable technologies, or satellite technologies.

The present invention provides a method and device for teaching a given language to one or more users. This is accomplished by use of a media series for teaching a given language to one or more users wherein the media series comprises the given language as well as language other than given language. The media series is made up of a plurality of series levels or lessons, which sequentially contain an increasing percentage of the given language. A user is exposed to the media series by progressively exposing the user to the series lessons in sequential fashion beginning with a first series lesson containing a lowest percentage of the given language and ending with a last series lesson containing a highest percentage of the given language. For example, the first series lesson contains a percentage of up to approximately thirty percent (30%) of the given language, and the last series lesson contains a percentage of more than approximately eighty percent (80%) of the given language. The last series lesson preferably is entirely in the given language.

The present invention provides a novel method and device for teaching languages to people and makes use of a systematic and entertaining approach to learning languages using singular or multiple media methodologies. Utilizing the method and device according to this invention, a user is progressively exposed to lessons in a desired media with a continually increasing percentage of the language to be learned. The use of a digital interactive communication media allows for the structured, controlled and dynamic implementation of the PI Language Method. The series of lessons can be distributed in a controlled and structured manner, which may be based upon interactive feedback, including the results of tests and drills by the user. When a user is a quick learner, the pace may be stepped up while a slow learner may be presented with additional lessons, which incrementally slow the pace. The ability of the digital interactive implementation enables the learning pace to be dynamically evaluated and adjusted on an individual basis.

A media series for teaching a given language to one or more users wherein the media series comprises the given language as well as language other than the given language. The media series preferably comprises a foreign language to be learned and the user's “native” language. The media series is made up of a plurality of series levels or lessons, which sequentially contain an increasing percentage of the foreign language.

The media series can be utilized to expose a user to written, audible, visual, or written, audible and visual words, which preferably form a story. Each series lesson can include one or more stories, and the material in each series lesson can follow up or succeed the story or stories of a preceding series lesson. Alternatively, each series lesson can contain an entirely new story or stories not related to either of the other series lessons, or each series lesson can present an identical story as the other series lessons while only differing from the other series lessons by the content amount of the foreign language. It is also envisioned that the media series can include stories, which impart a moral or ethical message. Regardless of the connection or lack of connection that the story or stories within each series lesson have, each series lesson provides text, sounds, pictures or a combination thereof as the series lessons sequentially incorporate an increasing amount of the foreign language to be learned. Throughout each series lesson, it is preferred that the foreign language be strategically used so that the context within which the foreign language is used makes the translation and meaning of the foreign language obvious and intuitive.

According to the method and device of this invention, the first series lesson contains the lowest percentage of the foreign language, which preferably is no greater than approximately thirty percent (30%), but can be zero. The last series lesson contains the highest percentage of the foreign language, and most preferably that percentage is one hundred percent (100%) so that by the time the user reaches the end of the media series, the user sees, hears, or sees and hears the last lesson completely in the foreign language. There can be any number of series lessons between the first and last series lessons, and the percentage content of the foreign language in these series lessons can vary as desired. As an example, a second lesson could be twenty-five percent (25%) foreign language and seventy-five percent (75%) native language; a third lesson could be half foreign language and half native language; and a fourth lesson, leading up to a final fifth lesson, could be seventy-five percent (75%) foreign language and twenty-five percent (25%) native language. It can frequently be desirable to vary the percentage content of foreign language depending upon the type of media utilized, as described further below.

### Textual Media Application

The media series according to this invention can comprise textual material such as one or more printed books or booklets. In this format, each series lesson in the media series consists of a written story or stories, which can be read by a user. The first series lesson in this format includes a low percentage of the foreign language, for example, up to approximately fifteen percent (15%). The successive series lessons in this format each have an increased percentage of the foreign language from a preceding series lesson until the last series lesson is reached which preferably is written entirely in the foreign language. Each successive series lessons in this media series includes foreign words already learned in a previous series lesson plus additional foreign words or alternatively includes completely new and unrelated foreign words.

When the media series comprises textual material, it is contemplated according to this invention that words of the chosen foreign language can be caused by the user to be selectively audibly pronounced by the user activating one or more audio chips, which can be included in the media series. The foreign word or words pronounced typically are represented by a picture used in association with the story text. In this manner, the user can hear a foreign word or words expertly pronounced. It is also envisioned according to this invention that this format utilizing an audio chip to pronounce representative pictures can exist by itself without accompanying textual material.

### Audible Media Application

The media series according to this invention can comprise audible material, which is electronically stored sound material. The specific types of audible materials, which can be used are one or more cassette tapes and/or compact discs, however, these are provided as examples and not as a limitation, and it is envisioned that other specific formats could be utilized for the electronically stored sound material.

When the media series comprises audio material, a user can listen to each of the series lessons sequentially. It is envisioned according to this invention that the audible material can be utilized by itself, or that textual, pictorial or a combination of such materials can be utilized in association with the audible material.

### Audiovisual Media Application

The media series according to this invention can also comprise audiovisual material. This audiovisual material preferably is electronically stored sound and visual material, and can be in the form of, for example, one or more videotapes or electronically stored sound and visual material adapted for use on a computer, such as one or more compact discs, diskettes and/or digital videodiscs (DVD's). When the media series comprises electronically stored sound and visual material, a user can cause the media series to be electronically processed in order for the user to simultaneously listen to and view the series lessons within the media series.

When the media series comprises one or more videotapes, the series lessons strategically utilize foreign language inserted in such a way as to enable the user to readily understand, almost intuitively, the meaning of the foreign language. This can be accomplished by use of gestures of a character in the videotape, which make the meaning of one or more foreign words obvious. An example of this situation is where a character in the video tape asks, “does a dog bark?”, whereupon another character replies “oui”. The responding character can even nod his or her head while saying “oui”, thereby reinforcing the context surrounding the use of the foreign word and obviating the need for any explanation.

The second series lesson of the media series comprising videotapes can contain foreign words already used in the first series lesson, additional foreign words that are inserted to enhance or modify foreign words used previously in a series lesson, such as the “big” house or the “big, red” house, or can contain completely new and independent foreign words unrelated to the previous series lessons. The second and successive series lessons can double or more than double the percentage of foreign word content from a previous series lesson as desired. Thus, a user progresses sequentially through the series lessons with increased exposure to the foreign language until the last series lesson is reached which comprises only the foreign language and no other language. A user's attention and interest is therefore focused by a series of related or unrelated stories, which teach the user while keeping the user entertained so that the user is often substantially unaware that the foreign language is being learned.

The media series according to this invention can comprise electronically stored sound and visual material adapted for presentation on a computer. In this manner, the media series can be processed on a computer and the user can interact with the series lessons as described further below. It is also envisioned that a computer can be used to process either the electronically stored sound information or the electronically stored visual information by itself, however, it is preferred that both sound and visual electronically stored material be presented by processing the media series on a computer for best potential comprehension and in light of the growing multi-media aspects of computers.

Utilizing a computer, the series lessons can be visually, audibly, or visually and audibly perceived by the user. It is contemplated that various parameters can exist and that a user can select ranges within the parameters regarding the content of each series lesson before or after it is presented while the series lessons as a whole continue to sequentially contain an increased percentage of the foreign language. An example of one such parameter that can be selected by the user is the precise percentage of foreign language included within a given series lesson which effectively allows the user to select the difficulty based upon the user's foreign language proficiency. Another example of a parameter, which can be controlled to an extent by the user is that the user can select and control the speed at which the presentation is given.

When a user is allowed to control the percentage of foreign language content in a given series lesson, the percentage which can be selected can be controlled by the computer to be between a predetermined minimum and maximum for each series lesson. Furthermore, it is envisioned that an interactive means can be utilized with the computer in order for the user to demonstrate a requisite understanding or comprehension of certain foreign language in order to advance to a successive series lesson. This demonstration of comprehension by the user can be in the form of the user responding to audio cues, pointing to illustrations, answering written queries, or any other method of analysis. Additionally, it is envisioned that during a computer presentation of a series lesson according to this invention, a user can pause the presentation and point and click on any illustrated object in the presentation whereupon the foreign language name or phrase of the object is identified to the user. Utilizing a computer to present the media series according to this invention also allows multiple users to utilize the media series, provides means for storing information regarding each particular users progress through the media series and even allows a user to stop a lesson and resume the lesson at a later date picking up exactly where he or she left off.

It is therefore seen that the present invention provides a novel method and device for teaching a given language to one or more users. The present invention can be in multiple media forms for teaching one or more given languages systematically, effectively and easily to users of all ages. Advantageously, the present invention can be utilized by a single user without the need for participation or guidance by others.

It can also be appreciated that the present invention provides a method and device for teaching a given language, which draws a user's interest and attention wherein each user is entertained while learning. The method and device of this invention can be used to teach a user a foreign language while the user is substantially unaware of the learning as it occurs.

The method uses digital converting technology to implement the PI Language Method described above, to be interactive over digital television, which is delivered either through usual broadcast technologies, cable technologies, or satellite technologies.

The PI Language Method is a method and device for teaching languages. A user is progressively exposed to the media series by exposing the user to the series lessons in sequential fashion beginning with a first series lesson containing a lowest percentage of a given language and ending with a last series lesson containing a highest percentage of the given language. The new method for digitally converting the PI Language Method will permit the transmission of various series using interactive digital television and/or downloading over an electronic network, such as the Internet.

The present invention relates to the digital conversion of audiovisual material which has been modified using the PI Language Method for purposes of rendering the material interactive and suitable for 1) digital television which is delivered to users via broadcast, cable, or satellite, 2) suitable for downloading the entire digitalized material over an electronic network, such as the Internet, via dial-up telephone, cable, or satellite technologies, or 3) suitable for downloading only the audio portion of a series of the PI Language Method over existing audiovisual material modified with the PI Language Method without altering the video portion of said material, over an electronic network, such as the Internet, via dial-up telephone, cable, or satellite technologies.

The following descriptions serve as exemplary embodiments of the present invention.

1. The PI Language Method is applied to audiovisual material before the material is converted to a digital format that is used for interactive digital television such that the material can be shown to users over their television for purposes of learning languages. This format also permits an interactive approach to language learning that utilizes the capabilities of interactive digital television technologies, such that users can modify the learning process to suit their needs and learning capabilities. This can involve progressing through different series at different rates than other users, or involve the ability to incrementally increase the amount of foreign language in a given series (i.e. increasing the foreign content from 40% to 55%, instead of going to the 70% level)

2. Users of the interactive digital television transmission of the PI Language Method might wish to download versions of the material for storage on a more permanent digital storage medium, such as CD-ROMs or DVD, and as such this invention will allow the digital downloading of the PI Language Method material to such storage media via dial-up telephone, cable, or satellite technologies over an electronic network, such as the Internet. This material will contain encryption technology to prevent unauthorized copying of the material.

3. Users of purchased or downloaded material modified by the PI Language Method may wish to receive new series of the PI Language Method (i.e. different levels), or new languages on their existing material. This new invention will permit the digital downloading of only different audio portions of the material without altering the video portion of the material, and this downloading can be done using dial-up telephone, cable, or satellite technologies. This would permit the greatest flexibility in modifying the audio portions of the PI Language Method material, without the need to re-acquire the video portion, thus greatly reducing the time and cost to modify their existing material.

In view of the foregoing description, numerous modifications and alternative embodiments of the invention will be apparent to those skilled in the art. Accordingly, this description is to be construed as illustrative only and is for the purpose of teaching those skilled in the art the best mode of carrying out the invention. Details of the structure may be varied substantially without departing from the spirit of the invention, and the exclusive use of all modifications, which come within the scope of the appended claim, is reserved.

We claim:

1. A method for teaching a user a foreign language comprises the following steps:
providing the user with audio and visual material in digital format;
exposing the user to the audio visual material in digital format, wherein the audio visual material in digital format contains a predetermined amount of foreign language content; and,
progressively increasing the predetermined amount of foreign language content.

2. The method as recited in claim 1 wherein the step of providing the user further comprises providing the user with audio and visual material in digital format over a communication network.

3. The method as recited in claim 1 further comprising selecting the predetermined amount of foreign language content dynamically in response to the user.

4. The method as recited in claim 1 further comprising testing the user interactively.

5. The method as recited in claim 1 wherein the step of exposing the user to the audio visual material in digital format uses interactive digital television.

6. The method as recited in claim 2 wherein the communication network comprises a wireless network.

7. The method as recited in claim 1 wherein the step of progressively increasing the predetermined amount of foreign language content uses a series of lessons with an initial lesson having lowest predetermined amount of foreign language and a final lesson having highest predetermined amount of foreign language.

8. The method as recited in claim 1 wherein the step of providing the user further comprises providing the user with audio and visual material in digital format on a digital storage media.

9. The method as recited in claim 1 wherein the step of providing the user further comprises providing the user with audio and visual material in digital format uses real-time video streaming.

10. A system for teaching a user a foreign language comprises:
audio and visual material in digital format;
an interactive digital television for exposing the user to the audio visual material in digital format, wherein the audio visual material in digital format contains a predetermined amount of foreign language content; and,
means for progressively increasing the predetermined amount of foreign language content.

11. The system as recited in claim 10 wherein the audio and visual material in digital format is provided over a communication network.

12. The system as recited in claim 10 wherein the predetermined amount of foreign language content is selected in response to the user's interactions.

13. The system as recited in claim 10 further comprising means for testing the user interactively.

14. The system as recited in claim 11 wherein the communication network comprises a wireless network.

15. The system as recited in claim 11 wherein the communication network comprises a world wide packet switching network.

16. The system as recited in claim 11 wherein the progressively increasing predetermined amount of foreign language content uses a series of lessons with an initial lesson having lowest predetermined amount of foreign language and a final lesson having highest predetermined amount of foreign language.

17. The system as recited in claim 11 wherein the audio and visual material in digital format is on a digital storage media.

18. The system as recited in claim 11 wherein the audio and visual material in digital format is presented in real-time video streaming.

19. The system as recited in claim 11 wherein the audio and visual material in digital format contains more than one foreign language such that different foreign languages can be presented with the same audio visual material.

20. The system as recited in claim 11 wherein the audio and visual material in digital format is encrypted to prevent unauthorized copying.
